(19) United States
(12) Patent Application Publication
(10) Pub. No.: US 2021/0279667 A1
(43) Pub. Date: Sep. 9, 2021

(54) METHOD AND COMPUTER READABLE STORAGE MEDIUM FOR AGENT MATCHING IN REMOTE INTERVIEW SIGNATURE

(71) Applicant: Ping An Technology (Shenzhen) Co., Ltd., Guangdong (CN)

(72) Inventor: Hua NIU, Guangdong (CN)

(73) Assignee: Ping An Technology (Shenzhen) Co., Ltd., Guangdong (CN)

(21) Appl. No.: 16/466,284

(22) PCT Filed: Feb. 27, 2018
(86) PCT No.: PCT/CN2018/077415

§ 371 Date: Jun. 3, 2019

(30) Foreign Application Priority Data
Dec. 1, 2017 (CN) 2017112583387

(51) Int. Cl. G06Q 10/06; H04M 3/523

(52) U.S. Cl. CPC G06Q 10/063112; H04M 3/5232

(57) ABSTRACT

The present disclosure discloses a remote interview signature agent matching method, an electronic device and a computer memory readable storage medium, said method comprising the following steps: Step 01, an user end inquiring whether there is an interview signature task, if so, then going to Step 02, otherwise ending the method; Step 02, the user end sending an interview signature request to an agent end, wherein the interview signature request includes user information and business information, the agent end confirming the user information and the business information; Step 03, the agent end allocating the interview signature request to a matching agent according to preset allocation strategy; Step 04, the matching agent performing matching check of user information and business information on the interview signature request, if matching is successful, connecting to incoming call user, otherwise returning to Step 03 for reallocation.

The present disclosure declares priority of the Chinese patent application with number CN2017112583387, filed on Dec. 1, 2017, entitled “Method, electronic device and computer readable storage medium for remote interview signature agent matching”. Entire content of the Chinese patent application is incorporated in the present disclosure by reference.

### BACKGROUND

The present disclosure relates to a business allocating method, particularly to a remote interview signature agent matching method and a computer readable storage medium.

A kind of social industries represented by financial industries such as banking, securities, insurance and so on, when providing business to public, need to check true identity of the parties, that is, need work in the verification of the real-name system. Existing way requires the parties themselves to go to the counter, provide valid personal identification documents, and express their true wishes and to sign relevant documents, that is, “interview signature”. Existing interview signature is generally initiated by user end, and agent end is connected. The user end can initiate the interview signature request by video or voice call. After receiving the interview signature request, the agent end needs to further assign the request to corresponding agent. Existing incoming call allocation process, including allocation of the customer to the agent or allocation of task of outgoing call on detection, is according to the basic sequential allocation manner, which causes such problem that as the difference between the agent business skills and the customer's business needs, sometimes problem of customers cannot be solved well, good quality of business cannot be reached, and reasonable allocation of customers or reasonable allocation of tasks of outgoing call cannot be achieved, thus call allocation efficiency is low.

### SUMMARY

An object of the present disclosure is to provide a remote interview signature agent matching method, an electronic device and a computer readable storage medium, thereby overcoming the problems existing in the prior art to a certain extent.

The present disclosure addresses the above technical issues through the following technical solutions:

The present disclosure provides a remote interview signature agent matching method, comprising the steps of:

Step 01, an user end inquiring whether there is an interview signature task, if so, then going to Step 02, if not, then ending the method;

Step 02, the user end sending interview signature request to the agent end, wherein the interview signature request includes the user information and business information, and the agent end confirming the user information and the business information;

Step 03, the agent end allocating the interview signature request to the matching agent according to the preset allocation strategy;

Step 04, the matching agent carrying out matching check of user information and business information on the interview signature request, if matching is successful, connecting to the incoming call user, otherwise returning to Step 03 for reallocation.

The present disclosure also provides an electronic device comprising a memory and a processor, wherein said memory is for storing a remote interview signature agent matching system executed by the processor, the remote interview signature agent matching system comprising:

an interview signature task query module which is set at the user end for querying whether there is an outstanding interview signature task, wherein the module carries out information interaction with the agent end through an interface;

an interview signature information confirmation module which is set at the agent end for confirming user information of the interview signature user, including identity information and loan information;

an agent allocation module for allocating the interview signature user to corresponding agent according to the preset allocation strategy;

agent matching judgment module for checking the business matching between the assigned interview signature user and the agent, if matching each other, carrying out next operation, if not matching, returning to the agent allocation module for reallocation.

The present disclosure also provides a computer-readable storage medium in which a remote interview signature agent matching system is stored, and the remote interview signature agent matching system can be executed by at least one processor, to enable the at least one processor to perform the following steps of the remote interview signature agent matching method:

Step 01, an user end inquiring whether there is an interview signature task, if so, then going to step 02, if not, then ending the method;

Step 02, the user end sending interview signature request to the agent end, wherein the interview signature request includes the user information and business information, and the agent end confirming the user information and the business information;

Step 03, the agent end allocating the interview signature request to the matching agent according to the preset allocation strategy;

Step 04, the matching agent carrying out matching check of user information and business information on the interview signature request, if matching is successful, connecting to the incoming call user, otherwise returning to Step 03 for reallocation.

The details of one or more embodiments of present disclosure are set forth in the accompanying drawings and the description below. Other potential features, objects, and advantages of the present disclosure will become apparent from the description, the drawings, and the claims.

### BRIEF DESCRIPTION OF THE DRAWINGS

FIG. 1 shows a flowchart of a remote interview signature agent matching method according to an embodiment of the present disclosure;

FIG. 2 shows a flowchart of a remote interview signature agent matching method according to another embodiment of the present disclosure;

FIG. 3 shows a flowchart of a remote interview signature agent matching method according to another embodiment of the present disclosure;

FIG. 4 shows program modules of a remote interview signature agent matching system according to an embodiment of the present disclosure;

FIG. 5 shows program modules of a remote interview signature agent matching system according to another embodiment of the present disclosure;

FIG. 6 shows hardware architecture of an electronic device according to another embodiment of the present disclosure.

### DETAILED DESCRIPTION

### Embodiment 1

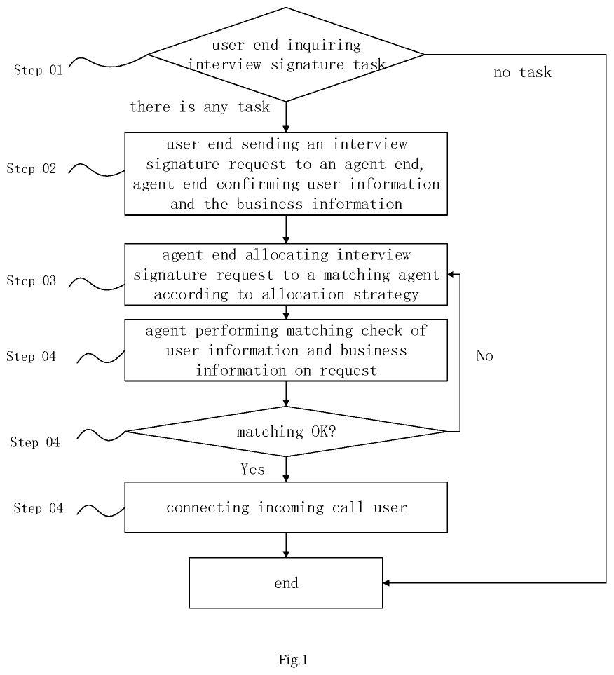

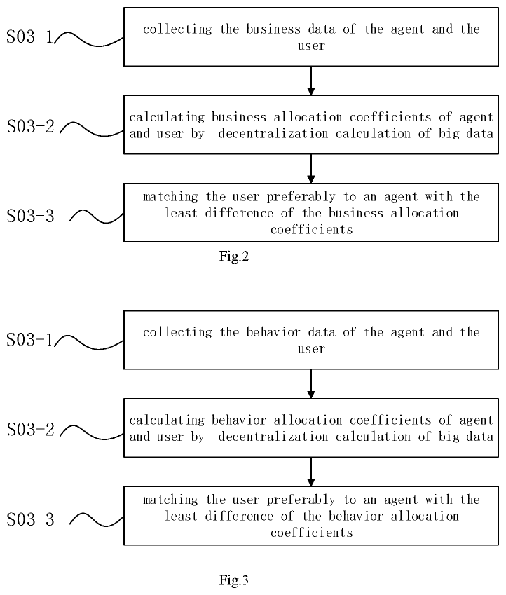

Referring to FIGS. 1 and 2, it is shown a remote interview signature agent matching method, comprising the steps of:

Step 01, an user end inquiring whether there is an interview signature task, if so, then going to step 02, if not, then ending the method;

In this step, the user for interview signature enters ID number in the user end, logs in the interview signature system to inquire whether there is an interview signature task, if so, initiates the call request to the agent end to start the interview signature, if not, then exits inquiry page. In detail, the user end can be self-help inquiry machine, PC terminal, mobile phone terminal or tablet computer end. By inputting ID number through the user end in interview signature inquiry page, it is queried whether there is an interview signature task for loan.

Step 02, the user end sending interview signature request to the agent end, wherein the interview signature request include the user information and business information, the agent end confirming the user information and the business information;

In this step, after receiving interview signature request sent from the user end, the agent end acquires the user's basic information according to the user's login identity information, and allocates the user to corresponding agent according to the preset allocation strategy. The agent end extracts the business information and personal basic information of the user in the system according to the user's ID or ID number for information confirmation. After the information is confirmed, the agent end carries out the next operation to the incoming call user.

Step 03, the agent end allocating the interview signature request to the matching agent according to the preset allocation strategy;

In the step, business allocation coefficient of the agent and business allocation coefficient of the user are calculated according to the business data of the agent and the user, and a first allocation is made to the interview signature user according to the business allocation coefficients. Specifically, the step includes the following sub-steps:

S03-1, collecting the business data of the agent and the user, wherein the business data of the agent include work time of the agent, customer satisfaction rate, business proficiency, etc., in which the business data of the user includes business product information under name of the user, loan information, whether VIP customer or not, call times and so on;

S03-2, by using big data's decentralization calculation manner, obtaining influence depth and breadth of each business data of the agents and the users from big data, obtaining rational score value of each business data for carrying out weighted statistics to get the business allocation coefficients of the agents and the users.

The business assignment coefficient of the agent can be calculated as follows:

Influencing factors in business data of the agent include: total working time T, working time of the day T, customer satisfaction rate S, personal business proficiency α, comprehensive evaluation β of personal business quality. The business allocation coefficient of the agent is obtained by comparing current agent with average level:

business allocation coefficient of the agent

$${δ}_{i} = \frac{{T}_{i}}{{T}_{average}} + \frac{8}{{t}_{i}} + \frac{{s}_{i}}{{s}_{average}} + \frac{{a}_{i}}{{a}_{average}} + \frac{{β}_{i}}{{β}_{average}}$$

Where i stands for clerk code;

The T_{average} represents average of the total working time of all the clerks;

Tᵢ represents working time of each clerk;

tᵢ stands for the working time of each clerk on the day;

S_{average} represents average satisfaction rate of all clerks;

Sᵢ represents the satisfaction rate of each clerk;

a_{average} represents the average proficiency of all clerks;

aᵢ represents the business operational proficiency of each clerk;

β_{average} represents the average level of comprehensive evaluation of all clerks;

βᵢ represents the comprehensive evaluation level of each clerk.

The business assignment coefficient of the user can be calculated as follows:

Influencing factors in business data of the user include: number of customer calls, whether existing customers or not, customer assets, customer degree of good rating;

Where k is customer number;

Nₖ is the number of customer calls;

Hₖ is whether existing customer or not; if the customer is an existing valid customer, the coefficient Hₖ is increased;

Mₖ is the amount of customer assets;

M_{average} is average of customer assets;

Eₖ is a customer degree of good rating; for a new customer, default thereof is average;

E_{average} is the average level of customer degree of good rating.

S03-3, matching the user preferably to an agent with the least difference of the business allocation coefficient, determining whether preferably allocated agent is in the idle state, if the agent is in the idle state, the user is connected to the agent, and if the agent is answering the telephone from other users, another agent with similar business allocation coefficient is selected.

Step 04, the matching agent carrying out matching check of user information and business information on the interview signature request, if matching is successful, connecting to the incoming call user, otherwise returning to Step 03 for reallocation.

In this step, the agent carries out matching check between the business information allocated to the user for interview signature in the task list and the business information for which the agent is responsible. If matching rate is on or above 90%, the matching is deemed to be successful, and if matching rate is lower than 90%, the matching is considered to be a failure. The agent sends requested user with failed matching back to the allocation module for reallocation.

In the embodiment, the business data of the user is matched with the business data of the agent, an exclusive agent of the incoming call user for interview signature is set. When customer initiates call request for interview signature, according to the business data of the user, it is matched to an agent with the most matched business data, thereby improving the validity of incoming call matching and the quality of business service.

### Embodiment 2

Referring to FIG. 3, it is shown another remote interview signature agent matching method, comprising the steps of:

Step 01, an user end inquiring whether there is an interview signature task, if so, then going to step 02, if not, then ending the method;

In this step, the user for interview signature enters ID number in the user end, logs in the interview signature system to inquire whether there is an interview signature task, if so, initiates the call request to the agent end to start the interview signature, if not, then exits inquiry page. In detail, the user end can be self-help inquiry machine, PC terminal, mobile phone terminal or tablet computer end. By inputting ID number through the user end in interview signature inquiry page, it is queried whether there is an interview signature task for loan.

Step 02, the user end sending interview signature request to the agent end, wherein the interview signature request include the user information and business information, the agent end confirming the user information and the business information;

In this step, after receiving interview signature request sent from the user end, the agent end acquires the user's information according to the user's login identity information, and allocates the user to corresponding agent according to the preset allocation strategy. The agent end extracts the business information and personal basic information of the user in the system according to the user's ID or ID number for information confirmation. After the information is confirmed, the agent end carries out the next operation to the incoming call user.

Step 03, the agent end allocating the interview signature request to the matching agent according to the preset allocation strategy;

In the step, behavior allocation coefficient of the agent and behavior allocation coefficient of the user are calculated according to the behavior data of the agent and the user, and a first allocation is made to the interview signature user according to the behavior allocation coefficients. Specifically, the step includes the following sub-steps:

S03-A, collecting behavior data of the agent and the user, wherein the behavior data of the agent includes fatigue degree evaluation behavior data and user evaluation behavior data, in which the fatigue degree evaluation behavior data is obtained according to the work time and the working hour of the agent. The user evaluation behavior data is obtained according to evaluation data of the user to the agent; the behavior data of the user includes the behavior data for determining whether the user is a harassing user according to the time and frequency of the incoming call from the user, behavior data of the user behavior evaluation obtained according to the historical evaluation of the user given by the agent.

S03-B, by using big data's decentralization calculation manner, obtaining influence depth and breadth of each business data of the agents and the users from big data, obtaining rational score value of each business data for carrying out weighted statistics to get the business allocation coefficients of the agents and the users.

S03-C, matching the user preferably to an agent with the least difference of the business allocation coefficient, determining whether preferably allocated agent is in the idle state, if the agent is in the idle state, the user is connected to the agent, and if the agent is answering the telephone from other users, another agent with similar business allocation coefficient is selected.

Step 04, the matching agent carrying out matching check of user information and business information on the interview signature request, if matching is successful, connecting to the incoming call user, otherwise returning to Step 03 for reallocation.

In this step, the agent carries out matching check between the business information allocated to the user for interview signature in the task list and the business information for which the agent is responsible. If matching rate is on or above 90%, the matching is deemed to be successful, and if matching rate is lower than 90%, the matching is considered to be a failure. The agent sends requested user with failed matching back to the allocation module for reallocation.

### Embodiment 3

The embodiment discloses a remote interview signature agent matching method, comprising the steps of:

S01, an user end inquiring whether there is an interview signature task, if so, then going to step 02, if not, then ending the method;

In this step, the user for interview signature enters ID number in the user end, logs in the interview signature system to inquire whether there is an interview signature task, if so, initiates the call request to the agent end to start the interview signature, if not, then exits inquiry page. In detail, the user end can be self-help inquiry machine, PC terminal, mobile phone terminal or tablet computer end. By inputting ID number through the user end in interview signature inquiry page, it is queried whether there is an interview signature task for loan.

S02, the user end sending interview signature request to the agent end, wherein the interview signature request include the user information and business information, the agent end confirming the user information and the business information;

In this step, after receiving interview signature request sent from the user end, the agent end acquires the user's information according to the user's login identity information, and allocates the user to corresponding agent according to the preset allocation strategy. The agent end extracts the business information and personal basic information of the user in the system according to the user's ID or ID number for information confirmation. After the information is confirmed, the agent end carries out the next operation to the incoming call user. The preset allocation strategy in the step may adopt the allocation method in embodiment 1 or embodiment 2.

S03, the agent end carrying out authentication on the interview signature user, if the authentication passes, then entering S04; if the verification does not pass, reminding the user to go to the counter for the interview signature.

In this step, authentication includes ID verification and face recognition verification. The ID verification includes the identification and extraction of the user's ID validity and user information by using the ID card identification instrument. Face recognition verification includes collecting photos of users on site and conducting face recognition with photo of ID card or on third party identity information network for verification.

In a preferred embodiment, authentication specifically includes:

Step 03-1, the agent end sending an authentication instruction to the user end, after the user end receiving the instruction, the authentication instrument being turned on at the user end, and carrying on text and voice operation instructions on the user at user interface, including reminding the user to place the ID card in a specified area, and adjusting the brightness of the client and other collection parameters; the authentication instrument scanning the ID card to extract the photo of the head and the ID number information on the ID card, and performing de-textured processing on the head photo; sending processed photo and the ID number information to the file server at the user end and forming an identification ID code for extracting the photo and the information; the user end sending the identified ID code to the agent end.

Step 03-2, the agent end verifying the validity of the ID information, if verification is passed, entering next step, and if the verification is not passed, reminding going back to the user end for re-collection; the agent end obtaining user's photo corresponding to the ID number from the verification network through the interface connected with the third-party identity verification network, while obtaining ID photo of head from the user end by identifying the ID code; comparing user photo from the verification network with collected ID photo of head to verification; if similarity of the two photos exceeds a first threshold, the verification is passed, and if the similarity is lower than the first threshold, the verification is not passed, wherein the first threshold can be 70, and the first threshold can be obtained by statistical analysis of the historical similarity value. This step can improves query efficiency so as to avoid the need to spend much time on authentication and problem of failing to query as ID card has expired. In practical application, it is also possible to directly determine whether the ID card is in the valid period according to current date of the system after collecting the valid date of the ID card, wherein, the third party identity verification network can be the public security network.

Step 03-3, the agent end carrying out face recognition verification to the user, if the verification is passed, entering the next step, if the verification is not passed, the user being reminded to go to the counter for verification with a valid certificate; after the ID verification is passed, the agent end activating face recognition sub-module to perform the face recognition verification on the user; the agent end sending the instruction to start the high camera to the user, after receiving the instruction, the user turning on the high cameral, and sending text and voice operation prompt to the user via the user interface; the user capturing face image on the site by the prompt, after that, sending photo back to the agent end; a face recognition module at the agent end comparing the face image with user head photo from the verification network; if the similarity from matching results of the two exceeds a second threshold value, the verification is passed; if the similarity is lower than the second threshold value, the prompt verification is not passed, then the agent end agent reminding the user to carry out the face recognition verification second time; if it still fails to pass, the user being reminded to go to the counter to handle the interview signature with the valid certificate, wherein the second threshold can be obtained by statistical analysis of the historical data and, preferably, the second threshold is 60.

Step 04, the user for interview signature signing, and signature file being named and archived at the agent end.

In this step, the user may choose to sign the paper document or the electronic document, wherein the paper signature is the user's signature on the paper application material for interview signature, and the signature material is placed under the high camera and sent back to the agent end. The agent end names and files the interview signature material. The electronic signature is to load and send the electronic contract list which needs the user's signature to the user end, and the user scans QR code on the contract to sign for confirmation.

In a preferred embodiment, a paper signature includes following processes: a user signs or seals on a corresponding signature part on an existing paper contract document, and all contract documents and signature pages are photographed under a high camera at the user end; after confirming the photo is clear and complete, it is sent back to the agent end, which then check whether the uploaded photo file content is consistent with the contract list, after confirm it, the signature material, contract, user face photos, ID photos archived and saved.

In a preferred embodiment, the electronic signature comprises following processes: the agent end checks the user information and generates the electronic contract document to be signed, sends the generated electronic contract document to the user end; the user scans the QR code on the document and signs it for confirmation, and sends it to the agent, which confirms that the signed contract document is correct, and then files and saves it.

### Embodiment 4

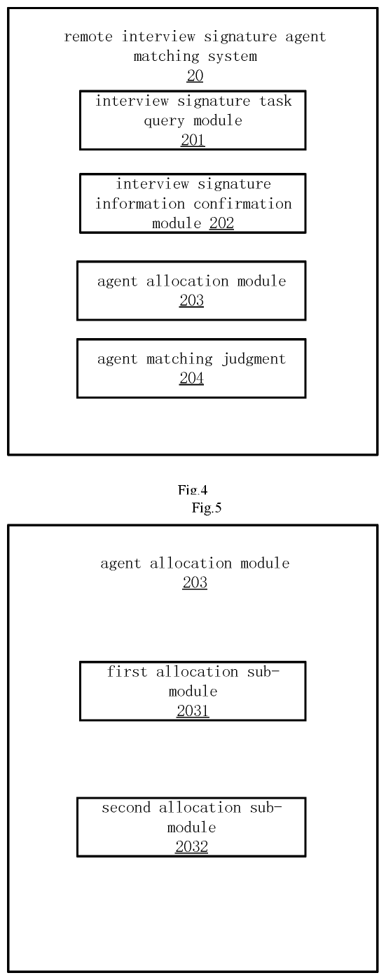

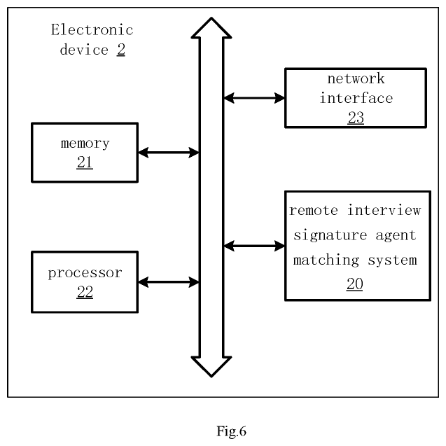

Referring to FIGS. 4 and 5, a remote interview signature agent matching system 20 is illustrated. In this embodiment, the remote interview signature agent matching system 20 is divided into one or more program modules, which are stored in a storage medium, and executed by one or more processors to complete the application. A program module for the purpose of the present disclosure is a series of computer program instruction segments capable of performing a specific function, which is more suitable than the program itself to describe the execution of the remote interview signature agent matching system 20 in a storage medium. The following descriptions will introduce in detail the functions of each program module in this embodiment:

an interview signature task query module 201, for the user to inquire whether there is an outstanding interview signature task; if so, the user sends corresponding interview signature request to an interview signature request processing module at the agent end; in the query module, the user for interview signature enters the ID card number in the user end to login interview signature system to query whether there is an interview signature task; if so, a call request is sent to the agent end to start the interview signature, if not, the query page is closed. Particularly, the user end is self-help inquiry machine, PC terminal, mobile phone terminal or tablet computer end; by inputting ID number through the user end in interview signature inquiry page, it is queried whether there is an interview signature task for loan;

an interview signature information confirmation module 202, for after the user finds the existence of outstanding interview signature task, initiating an interview signature request to the agent end; after the agent end receives the request, the user material is obtained according to the user login identity information for verification of the user information; after checking is passed, the user is sent to an agent allocation module 203;

the agent allocation module 203, for allocating the interview signature request to the matching agent according to a preset allocation strategy;

In a preferred embodiment, the agent allocation module includes a first allocation sub-module 2031 and a second allocation sub-module 2032, wherein the first allocation sub-module 2031 is for allocating according to a business allocation coefficients of the agent and the user, the second allocation sub-module 2032 is for allocating according to a behavior allocation coefficient of the agent and the user, wherein the first allocation sub-module comprises a business data collection unit, a business allocation coefficient calculation unit and a business allocation unit, the second allocation sub-module comprises a behavior data collection unit, a behavior allocation coefficient calculation unit and a behavior allocation unit, wherein the data collection unit is for collecting the business data and behavior data of the agent and the user, and the allocation coefficient calculation unit obtaining influence depth and breadth of each business data of the agents and the users from big data, by using big data's decentralization calculation manner, obtaining rational score value of each business data for carrying out weighted statistics to get the business allocation coefficients of the agents and the users; the allocation unit is for carrying out the user allocation according to the respective business allocation coefficient and the behavior allocation coefficient of the agent and the user;

an agent matching judgment module 204, for checking the business matching between the assigned interview signature user and the agent, if matching each other, carrying out next operation, if not matching, returning to the agent allocation module for reallocation.

### Embodiment 5

Referring to FIG. 6, this embodiment provides an electronic device, a schematic diagram of the hardware architecture of an electronic device of the embodiment of the present disclosure is shown. In this embodiment, the electronic device 2 is a device capable of automatically performing numerical calculations and/or information processing according to predefined or stored instructions. For example, it can be a smartphone, tablet, laptop, desktop computer, rack server, blade server, tower server, or cabinet server including stand-alone servers. Or a cluster of multiple servers), and so on. As shown, the electronic device 2 includes, but is not limited to, a memory 21, a processor 22, a network interface 23, and a remote interview signature agent matching system 20 that can be communicated with each other through a system bus. Of which:

The memory 21 includes at least one type of computer-readable storage medium. The readable storage medium includes flash memory, hard disk, multimedia card, card type memory (e.g., SD or DX memory, etc.), random access memory (RAM), static random access memory (SRAM), read only memory (ROM), electrically erasable. Programmable read-only memory (EEPROM), programmable read-only memory (PROM), magnetic memory, magnetic disk, optical disk, etc. In some embodiments the memory 21 may be an internal storage module of the electronic device 2 such as a hard disk or memory of the electronic device 2. In other embodiments, the memory 21 may also be an external storage device of the electronic device 2, such as a plugged hard disk provided on the electronic device 2, an intelligent memory card (Smart Media Card, SMC), secure digital (Secure Digital, SD) card, a flash memory card (Flash Card), and the like. Of course the memory 21 may also include both an internal storage module and an external storage device of the electronic device 2. In this embodiment, the memory 21 is generally used to store an operating system and various types of application software installed in the electronic device 2 such as the program code of the remote interview signature agent matching system 20 and the like. In addition, the memory 21 may also be used to temporarily store various types of data that have been or will be outputted.

The processor 22 may in some embodiments be a central processor (CPU) a controller a microprocessor or other data processing chip. The processor 22 is generally used to control the overall operation of the electronic device 2 such as performing control and processing related to data interaction or communication with the electronic device 2. In this embodiment, the processor 22 is used to run program code stored in the memory 21 or process data such as running the remote interview signature agent matching system 20 or the like.

The network interface 23 may include a wireless network interface or a wired network interface which is generally used to establish a communication connection between the electronic device 2 and other electronic devices. For example, the network interface 23 is used for connecting the electronic device 2 to an external terminal via a network establishing a data transmission channel and a communication connection between the electronic device 2 and the external terminal. The network can be a wireless or wired network such as an enterprise intranet, an Internet, a Global System of Mobile communication (GSM), a Wideband Code Division Multiple Access (WCDMA), a 4G network, a 5G network, a Bluetooth, Wi-Fi, and the like.

It is to be noted that FIG. 6 shows only an electronic device having components 20-23 but it is understood that it is not required to implement all of the shown components and that more or fewer parts can be implemented in lieu thereof.

In this embodiment, the remote interview signature agent matching system 20 stored in memory 21 may also be divided into one or more program modules, said one or more program modules being stored in memory 21, and executed by one or more processors (in this embodiment, processor 22) to complete the application.

For example FIG. 4 shows a schematic diagram of a program module of the first embodiment of the remote interview signature agent matching system 20, in which the remote interview signature agent matching system 20 may be divided into an interview signature task query module 201, an interview signature information confirmation module 202, an agent allocation module 203, and an agent matching judgment module 204. The program module referred to in the present disclosure refers to a series of computer program instruction segments capable of accomplishing a specific function, and is more suitable than a program to describe the execution process of the remote interview signature agent matching system 20 in the electronic device 2. The specific functions of the program module 201-204 have been described in detail in embodiment 4 and are not repeated here.

### Embodiment 6

This embodiment provides a computer-readable storage medium. The remote interview signature agent matching system 20 is stored on the computer-readable storage medium. When the remote interview signature agent matching system 20 is executed by one or more processors, the remote interview signature agent matching system 20 realizes the operation of the remote interview signature agent matching method or electronic device.

Through the description of the above embodiments it is clear to those skilled in the art that the above embodiments may be implemented by means of software plus the necessary common hardware platform or by hardware merely. However, in many cases, the former is the better way.

The above are only preferred embodiments of the present disclosure and are not intended to limit the patent scope of the present disclosure, where equivalent structure or equivalent process changes made using the contents of the present disclosure specification and the accompanying drawings, directly or indirectly applied in other related technical fields, are included in the patent protection of the present disclosure for the same reason.

1. A method comprising:
inquiring via a user terminal whether there is an interview signature task in an interview systems;
upon determining that there is an interview signature task in the interview system, sending via the user terminal an interview signature request to an agent terminal, wherein the interview signature request includes user information and business information, and the agent terminal is configured to confirm that the user information and the business information are correct;
allocating via the agent terminal the interview signature request to a matching agent according to a preset allocation strategy;
confirming via the matching agent whether user information and business information are matched with business information for which the matching agent is responsible; and
upon determining that the user information and the business information are matched with the business information, connecting to incoming call user.

2. The method of claim 1, wherein inquiring whether there is the interview task includes obtaining an ID number of a user to inquire whether there is an interview signature task in the interview system.

3. The method of claim 1, wherein further comprising extracting via the agent terminal the user information and the business information for confirmation after receiving the interview signature request from the user terminal.

4. The method of claim 1, wherein allocating the interview signature request to the matching agent includes:
calculating business allocation coefficient of the matching agent and business allocation coefficient of a user according to business data of the matching agent and the user, and
performing a first allocation to the user according to the business allocation coefficient of the matching agent and the business allocation coefficient of the user.

5. The method of claim 4, wherein allocating the interview signature request to the matching agent further includes:
collecting the business data of the matching agent and the user;
calculating respective business allocation coefficient of the matching agent and business allocation coefficient of the user by using decentralization calculation manner of big data,
obtaining influence depth and breadth of each business data of the matching agent and the user from big data,
obtaining rational score value of each business data for carrying out weighted statistics to get the business allocation coefficients of the matching agent and the user;
matching the user to a matching agent with least difference of the business allocation coefficient,
if the matching agent is in the idle state, then connecting the user, and
if the matching agent is answering call from another user, selecting another agent with similar business allocation coefficient as the matching agent.

6. The method of claim 1, wherein allocating the interview signature request to the matching agent includes:
calculating behavior allocation coefficient of the matching agent and business allocation coefficient of a user according to behavior data of the matching agent and the user, and
performing a second allocation to the interview signature request according to the behavior allocation coefficient of the matching agent and the business allocation coefficient of the user.

7. The method of claim 6, wherein allocating the interview signature request to the matching agent further includes:
collecting behavior data of the matching agent and the user;
calculating respective behavior allocation coefficients of the matching agent and behavior allocation coefficient of the user by using decentralization calculation manner of big data,
obtaining influence depth and breadth of each behavior data of the matching agent and the user from big data,
obtaining rational score value of each behavior data for carrying out weighted statistics to get the behavior allocation coefficients of the matching agent and the user;
matching the user to a matching agent with least difference of the behavior allocation coefficient,
if the matching agent is in the idle state, then connecting the user, and
if the matching agent is answering call from another user, selecting another agent with similar behavior allocation coefficient as that of the matching agent.

8. (canceled)

9. (canceled)

10. A computer-readable storage medium in which a remote interview signature agent matching system is stored, and the remote interview signature agent matching system can be executed by at least one processor, to enable the at least one processor to perform the following steps of the remote interview signature agent matching method:
inquiring via a user terminal whether there is an interview signature task;
sending via the user terminal an interview signature request to an agent terminal, wherein the interview signature request includes user information and business information, the agent terminal configured to confirm the user information and the business information;
allocating via the agent terminal the interview signature request to a matching agent according to preset allocation strategy;
performing via the matching agent matching check of user information and business information on the interview signature request; and
if the matching check is successful, connecting to incoming call user.

11. The computer-readable storage medium of claim 10, wherein inquiring whether there is the interview signature task includes obtaining an ID number of a user to inquire whether there is an interview signature task.

12. The computer-readable storage medium of claim 10, wherein sending the interview signature request to the agent terminal includes after receiving the interview signature request from the user terminal, extracting via agent terminal the user information and the business information for confirmation.

13. The computer-readable storage medium of claim 10, wherein allocating the interview signature request to the matching agent includes:
calculating business allocation coefficient of the matching agent and business allocation coefficient of the user according to business data of the matching agent and the user, and
performing a first allocation to the user according to the business allocation coefficient of the matching agent and business allocation coefficient of the user.

14. The computer-readable storage medium of claim 13, wherein allocating the interview signature request to the matching agent further includes:
collecting the business data of the matching agent and the user;
calculating respective business allocation coefficients of the matching agent and business allocation coefficient of the user by using decentralization calculation manner of big data,
obtaining influence depth and breadth of each business data of the matching agent and the user from big data,
obtaining rational score value of each business data for carrying out weighted statistics to get the business allocation coefficients of the matching agent and the user;
matching the user to a matching agent with the least difference of the business allocation coefficient,
if the matching agent is in the idle state, then connecting the user, and
if the matching agent is answering call from another user, selecting another agent with similar business allocation coefficient as the matching agent.

15. The computer-readable storage medium of claim 10, wherein allocating the interview signature request to the matching agent includes:
calculating behavior allocation coefficient of the matching agent and business allocation coefficient of a user according to behavior data of the matching agent and the user, and
performing a second allocation to the interview signature request according to the behavior allocation coefficient of the matching agent and the business allocation coefficient of the user.

16. The computer-readable storage medium of claim 15, wherein allocating the interview signature request to the matching agent further includes:
collecting behavior data of the matching agent and the user;
calculating respective behavior allocation coefficient of the matching agent and behavior allocation coefficient of the user by using decentralization calculation manner of big data,
obtaining influence depth and breadth of each behavior data of the matching agent and the user from big data,
obtaining rational score value of each behavior data for carrying out weighted statistics to get the behavior allocation coefficients of the matching agent and the user;
matching the user to a matching agent with the least difference of the behavior allocation coefficient,
if the matching agent is in the idle state, then connecting the user, and
if the matching agent is answering call from another user, selecting another matching agent with similar behavior allocation coefficient as the matching agent.
